(19) United States
(12) Patent Application Publication
(10) Pub. No.: US 2020/0344326 A1
(43) Pub. Date: Oct. 29, 2020

(54) CLOUD CONTROLLER PROVIDING ARCHITECTURE-BASED INSTALLATIONS

(71) Applicant: HEWLETT PACKARD ENTERPRISE DEVELOPMENT LP, Houston, TX (US)

(72) Inventor: Debdipta Ghosh, Bangalore (IN)

(21) Appl. No.: 16/820,469

(22) Filed: Mar. 16, 2020

(30) Foreign Application Priority Data
Apr. 29, 2019 (IN) 201941017040

(51) Int. Cl. H04L 29/08; G06F 9/455; G06F 9/4401

(52) U.S. Cl. CPC H04L 67/34; G06F 9/45541; G06F 2009/45595; G06F 9/4416; G06F 9/45558

(57) ABSTRACT

In some examples, a method can include detecting, with a cloud controller, a Central Processing Unit (CPU) architecture for a bare metal server; selecting, based on the detected CPU architecture, a specific bootloader, specific Operating System (“OS”) and specific Virtual Machine (“VM”) for the bare metal server; and installing the selected bootloader, OS, and VM on the bare metal server.

### BACKGROUND

Cloud computing has significantly affected the way Information Technology (“IT”) infrastructure is being consumed. With the help of virtualization technology, it is possible to deploy workloads using a variety of virtual infrastructure ranging from public cloud environments to on premise data centers that rely on local hardware. New workloads are continuously being created, deployed, and consumed for applications via such virtual infrastructure.

### BRIEF DESCRIPTION OF DRAWINGS

FIG. 1 is a flowchart for a method, according to an example.

FIG. 2 is a flowchart for a method, according to another example.

FIG. 3 is a flowchart for a method, according to another example.

FIG. 4 is diagram of a cloud controller to provide architecture-based installations, according to an example.

FIG. 5 is an example hypervisor table for a cloud installation server, according to an example.

FIG. 6 is a diagram of a computing device, according to an example.

FIG. 7 is a diagram of machine-readable storage medium, according to an example.

### DETAILED DESCRIPTION

The following discussion is directed to various examples of the disclosure. Although one or more of these examples may be preferred, the examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. Throughout the present disclosure, the terms “a” and “an” are intended to denote at least one of a particular element. In addition, as used herein, the term “includes” means includes but not limited to, the term “including” means including but not limited to. The term “based on” means based at least in part on.

With existing tools, cloud administrators are unable to manage both bare metal servers and guest Virtual Machines (“VM's”) from a single cloud controller when there are multiple architecture hypervisors present. Certain implementations of the present disclosure are directed to on demand cloud installation of a multi-architecture host and guest operating system from a single cloud controller. In some implementations, a method can include: (a) detecting, with a cloud controller, a Central Processing Unit (“CPU”) architecture for a bare metal server; (b) selecting, based on the detected CPU architecture, a specific bootloader, specific Operating System (“OS”) and specific Virtual Machine (“VM”) for the bare metal server; and (c) installing the selected bootloader, OS, and VM on the bare metal server.

Certain implementations of the present disclosure may allow for a tool to provide bare metal and VM installation where there are multiple architecture type hypervisors present. In some implementations, a cloud administrator does not need to install an OS on a hypervisor manually. Instead such an installation can, for example, be performed automatically by a cloud controller or other management system. Certain implementations can, for example, allow the enablement of cloud installation of architecture independent guest and manageability through, for example, a hybrid cloud provider. Certain implementations can, for example, provide a cost effective solution, as only one Controller node can be used to handle OS provisioning. Certain implementations can, for example, provide a way to automatically determine which OS is to be installed on a target hardware system (e.g., when an administrator is to manage a large pool of servers within an Infrastructure-as-a-Service environment). Other advantages of implementations presented herein will be apparent upon review of the description and figures.

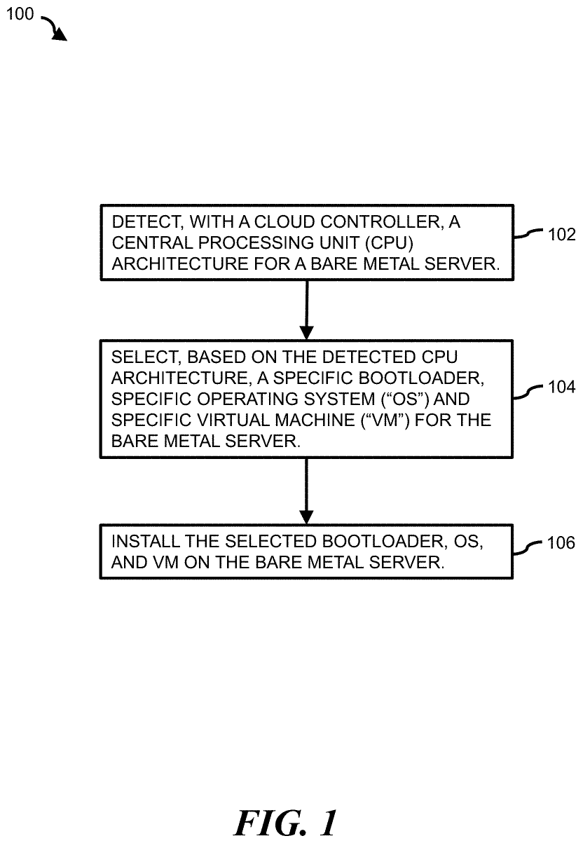

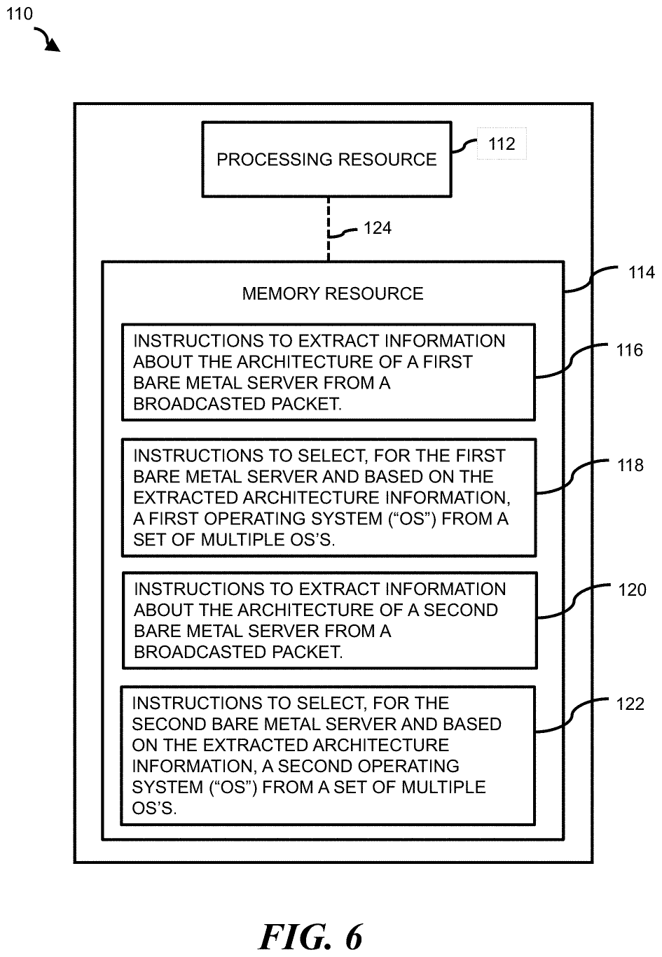

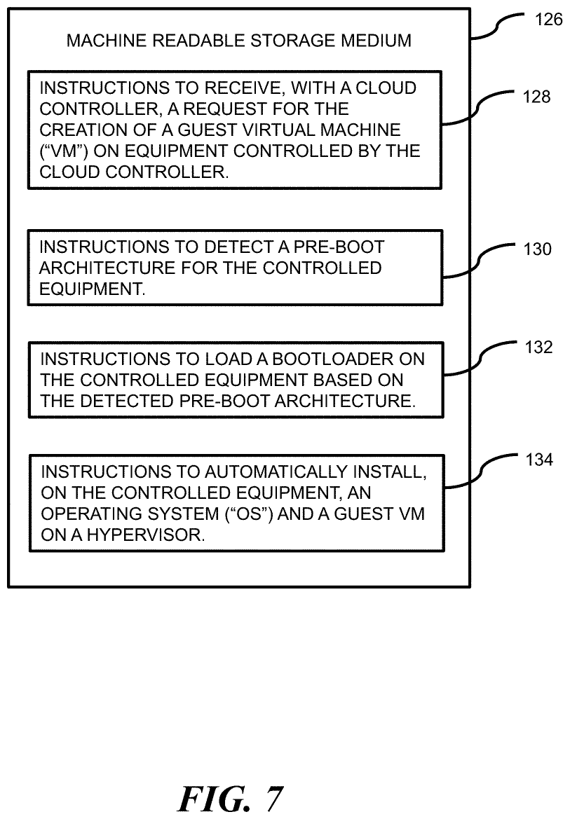

FIG. 1 depicts a flowchart for an example method 100 related to a cloud controller providing architecture-based installations. In some implementations, method 100 can be implemented or otherwise executed through the use of executable instructions stored on a memory resource (e.g., the memory resource of the computing device of FIG. 6), executable machine readable instructions stored on a storage medium (e.g., the medium of FIG. 7), in the form of electronic circuitry (e.g., on an Application-Specific Integrated Circuit (ASIC)), and/or another suitable form. Although the description of method 100 herein primarily refers to steps performed on a server for purposes of illustration, it is appreciated that in some implementations, method 100 can be executed on another computing device within a networked environment or in data communication with a networked environment. In some implementations, method 100 can be executed on network devices in parallel (e.g., in a distributed computing fashion).

Method 100 includes detecting (at block 102), with a cloud controller, a Central Processing Unit (CPU) architecture for a bare metal server. As described in further detail herein, in some implementations, detecting the CPU architecture is based on a received Dynamic Host Configuration Protocol (“DHCP”) packet broadcasted by the bare metal server during a Pre-boot eXecution Environment (“PXE”) boot. In some implementations, detecting the CPU architecture is based on a packet broadcasted by the bare metal server in the form of a DHCPDISCOVERY packet including a DHCP option 93 specified by RFC 4578. In some implementations, the bare metal server is a host server.

Method 100 includes selecting (at block 104), based on the detected CPU architecture, a specific bootloader, specific OS and specific VM for the bare metal server. The term “Virtual Machine” and related terms, can for example, refer broadly to an emulation of a computer system, device, or functionality thereof. It is appreciated that VMs are a popular mechanism for deploying public and private cloud computing application infrastructure. In some implementations, multiple instances of a VM can share the same physical hardware and each application VM can have its own set of OS, networking and storage. VMs can be based on computer architectures and provide functionality of one or more physical computers. VM implementations may involve specialized hardware, software, or a combination thereof. In some environments, a VM may be used to support separate operating systems (OS's), such as a system that executes a real-time OS simultaneously with a preferred complex OS. In some implementations, a process VM, sometimes called an application virtual machine, or Managed Runtime Environment (MRE), can run as a normal application inside a host OS and supports a single process. It can, for example, be created when a process is started and destroyed when it exits. Such an environment can be used to provide a platform-independent programming environment that abstracts away details of the underlying hardware or OS and allows a program to execute in the same way on any platform.

The present disclosure refers to the use of VMs throughout, however it is appreciated that the term “VM” can be broadly construed to include various suitable virtualization techniques, such as virtualized containers. For example, in some implementations, a VM can be in the form of a virtualized container. As used herein, the term “container” can, for example, refer to operating-system-level virtualization in which a kernel or other mechanism allows for multiple isolated user-space instances. Such instances can, for example, be referred to as containers, partitions, virtualization engines (“VEs”), jails, or another suitable term. Such instances can, for example, be designed to look like real computers from the point of view of programs running in them. In comparison to a conventional computer program, which may have visibility of all resources (e.g., connected devices, files and folders, network shares, CPU power, quantifiable hardware capabilities) of the computer running the program, programs running inside a container can be designed to have visibility limited to the container's contents and specific devices assigned to the container. Such containers can, in some implementations, include additional isolation mechanisms that can provide resource-management features to limit the impact of one container's activities on other containers.

Method 100 includes installing (at block 106) the selected bootloader, OS, and VM on the bare metal server. In some implementations, the cloud controller is to install a first OS on a hypervisor having a first architecture and the cloud controller is to install a second OS on a hypervisor having a second architecture, wherein the first and second OS's are different OS's and the first and second architectures are different architectures. In some implementations, a single cloud controller is to handle the respective installation of bootloaders, OS's, and VM's on multiple bare metal servers with different CPU architectures. In some implementations, the cloud controller provides an option for a manual override of the selected bootloader, OS, or VM.

It is appreciated that one or more operations of method 100 can be performed periodically. For example, in some implementations, one or more of blocks 102, 104, and 106 (or other operations described herein) may be performed periodically. The various period times for blocks 102, 104, and 106 (or other operations described herein) may be the same or different times. For example, in some implementations, the period of block 102 is every 1 minute and the period of block 104 is every 2 minutes. It is further appreciated, that the period for a given block may be regular (e.g., every 1 minute) or may be irregular (e.g., every 1 minute during a first network condition, and every 2 minutes during a second condition). In some implementations, one or more of block 102, 104, and 106 (or other operations described herein) may be non-periodic and may be triggered by some network or other event.

Although the flowchart of FIG. 1 shows a specific order of performance, it is appreciated that this order may be rearranged into another suitable order, may be executed concurrently or with partial concurrence, or a combination thereof. Likewise, suitable additional and/or comparable steps may be added to method 100 or other methods described herein in order to achieve the same or comparable functionality. In some implementations, one or more steps are omitted. For example, in some implementations, block 106 of installed the selected bootloader, OS, and VM can be omitted from method 100 or performed by a different device. It is appreciated that blocks corresponding to additional or alternative functionality of other implementations described herein can be incorporated in method 100. For example, blocks corresponding to the functionality of various aspects of implementations otherwise described herein can be incorporated in method 100 even if such functionality is not explicitly characterized herein as a block in method 100.

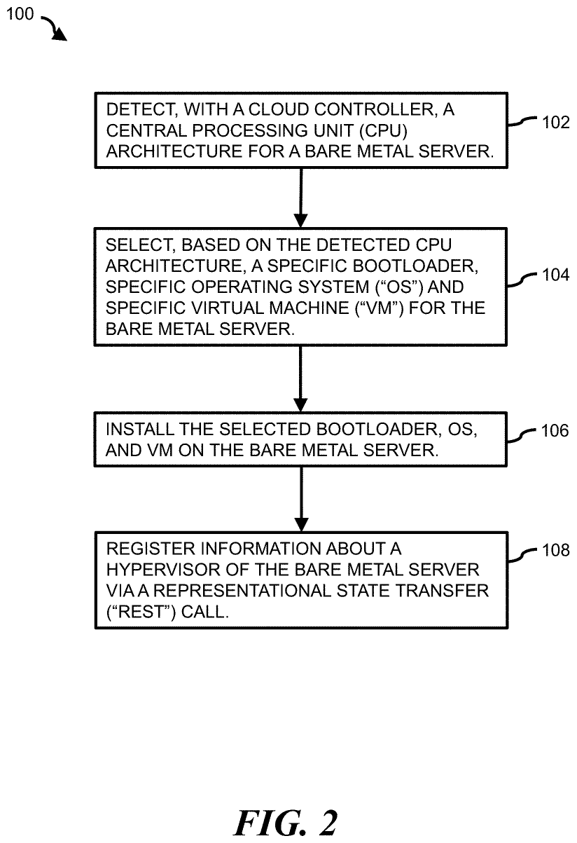

FIG. 2 illustrates another example of method 100 in accordance with the present disclosure. For illustration, FIG. 2 reproduces various blocks from method 100 of FIG. 1, however it is appreciated that method 100 of FIG. 2 can include additional, alternative, or fewer steps, functionality, etc., than method 100 of FIG. 1 and is not intended to be limited by the diagram of FIG. 1 (or vice versa) or the related disclosure thereof. It is further appreciated that method 100 of FIG. 1 can incorporate one or more aspects of method 100 of FIG. 2 and vice versa. For example, in some implementations, method 100 of FIG. 1 can include the additional step described below with respect to method 100 of FIG. 2.

Method 100 of FIG. 2 includes registering (at block 108) information about a hypervisor of the bare metal server via a Representational State Transfer (“REST”) call. In some implementations, the information about a hypervisor includes one or more of Media Access Control (“MAC”) Address, Architecture Type, amount of Random Access Memory (“RAM”), and CPU size. Further information regarding this operation is provided herein with respect to specific examples. In some implementations, the cloud controller is to install a hypervisor on the bare metal server.

Various example implementations for the present disclosure will now be described. It is appreciated that these examples may include or refer to certain aspects of other implementations described herein (and vice-versa), but are not intended to be limiting towards other implementations described herein. Moreover, it is appreciated that certain aspects of these implementations may be applied to other implementations described herein.

Certain implementations of the present disclosure relate to cloud based multi-architecture host and guest OS installation. Certain implementations provide for on demand cloud installation of multi-architecture host and guest operating system from single cloud controller. In such an implementation, the controller server can automatically install an OS on hypervisors having different architecture and requested guest on running hypervisors. On the receipt of a guest VM creation request, a first OS is installed on a bare metal server and a guest VM is then created on top of that server. In certain implementations, a single cloud controller is configured to detect target system's pre-boot architecture and loads architecture specific bootloader on target system, automatically install Host OS, configure the host with a hypervisor, and create a guest on top of the target system.

Certain implementations of the present disclosure can manage pool of bare metal servers with different architecture. Example of architectures are Arc x86, EFI IA32 (Details in RFC 4578), etc. OS installation on such bare metal servers can be achieved by detecting CPU architecture in DHCP broadcasted packet. Based on the architecture, a specific bootloader is loaded on a target client. In such an implementation, a single cloud controller can, for example, be configured with automation scripts and kickstart files for OS installation on client's disk.

In certain implementations, when a request fora specific guest is received, then based on the guest OS's CPU architecture a cloud controller can install an OS on bare metal first and then create a guest VM on top of the host. This whole method can, for example, be managed automatically through a single cloud controller by implementing the controller as an automation installation server. Based on a target client's architecture, the cloud controller can be pointed to a specific bootloader file to be loaded on client's ram before installing OS on target system's hard disk.

In certain implementations, a cloud controller can configure a PXE boot file that points location of a target OS to be loaded on target system. A post installation script from a kickstart file can install a hypervisor on the target system and can create a guest VM on top of the hypervisor. In some implementations, when a bare metal server is PXE booted, it broadcasts its architecture over a DHCP packet. A cloud controller configured with DHCP can send a bootstrap file to the target system depending on its architecture. As an example, a grub64x.efi or bootx64.efi bootstrap file can be provided for an x86 Linux installation, whereas an nbp.efi bootstrap file can be provided for HP-UX installation on an Itanium Architecture (“IA”) architecture. Using certain implementations, an out-of-box bare metal server may be used for example as a target host, whereas in certain existing solutions, a bootloader filer must be loaded in persistent memory.

In certain implementations, once the target node is selected for guest installation, the target system is booted and the cloud controller detects its architecture from DHCP. The client announces its architecture on boot as a part of the DHCP transaction. The first packet broadcasted by the client can, for example, be a DHCPDISCOVERY packet including the DHCP option 93 specified by RFC 4578. The cloud controller can then load an architecture specific bootloader in target system. A script triggered from a DHCP configuration can configure an OS in the cloud controller system and automatically install a host OS and hypervisor, then create a guest VM on the target system from post configuration script/kickstart script.

In certain implementations of the present disclosure, manageability of multiple architecture bare metal servers and VMs on Hybrid cloud environment can be achieved by introducing a “Cloud Installation Server” as a controller node. Configuring such a Cloud Installation Server with DHCP, TFTP and NFS can, for example, handle multiple architecture operation system installation from a single server. Through such a solution, a cloud administrator can manage bare metal systems and guest having diverse architectures. On guest creation request from admin, a first OS is installed on bare metal server and a guest VM can then be created on top of that server.

As provided above, a “Cloud Installation Server” can be a function of a cloud controller. Such a cloud installation server can, for example, maintain a registry of bare metal servers, which are of different architectures. For purposes of illustration, the term “bare metal system” and related terms (e.g., bare metal server, bare metal hypervisor, bare metal node, etc.) can, for example, refer to hypervisors are of x86 and IA types. However, it is appreciated that other suitable bare metal servers may be covered by the term.

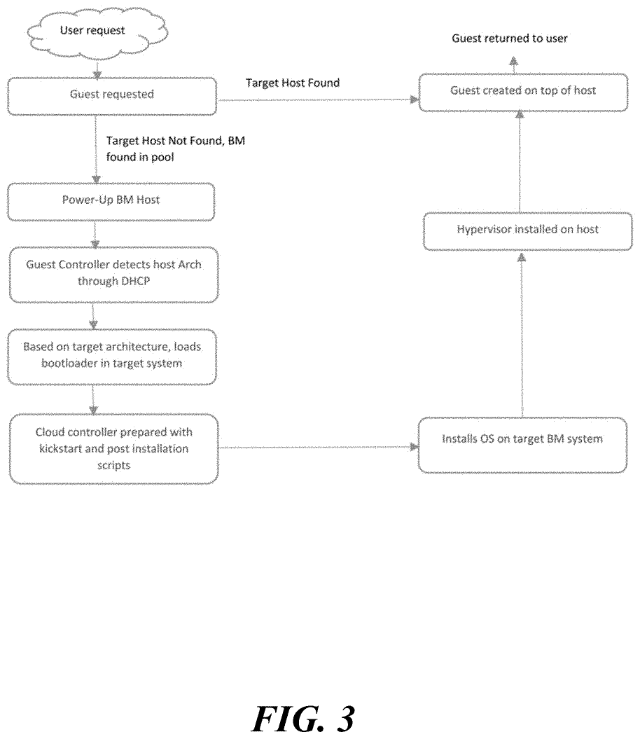

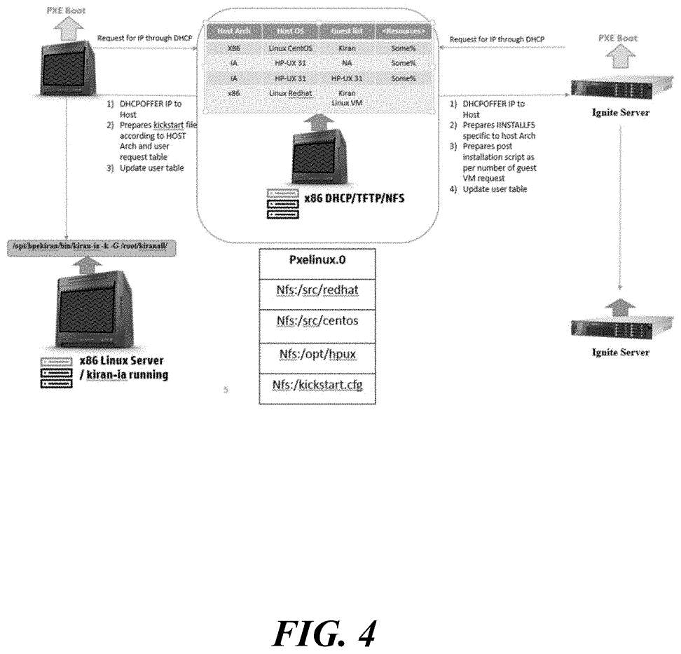

With reference to FIGS. 3 and 4, and according to certain example implementations, a method can include the following operations:

Cloud admin registers Bare-metal hypervisors through rest call:

/v1/registed<BM system details>

<BM System details> can, for example, include details such as MAC Address, Architecture Type, amount of RAM, amount CPU.

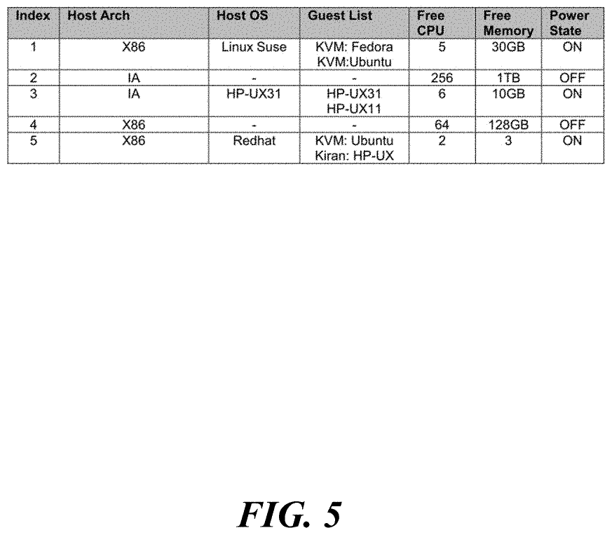

On request of registering a new hypervisor, “Cloud Installation Server” enters details in a “Hypervisor Table” (FIG. 5). Such hypervisors can, for example, be added in the cloud in a powered off state with no OS installed, as a bare metal system. Every bare metal node added in pool, have its MAC address entered in DHCP configuration file as below:

host hostname {
hardware ethernet <Mac Address of BM Host>
execute(″<Automation Program>, ″<Architecture of BM Host>″);
. . .
}

“Cloud Installation Server” is configured with DHCP, NFS, and TFTP. In certain implementations, the responsibility of this server is to automatically install OS on hypervisors having different architecture, and installation of requested guest VM on running hypervisors.

Request for creation of new guest VM comes from end user through rest call and handled by a cloud controller server.

/v1/newvmkguest details like os, cpu, ram, disk>

Based on new Guest OS/Architecture type, the cloud controller server can then try to find target Hypervisor (That is UP and RUNNING, having free resources to fit new guest configuration). The selection of host systems architecture will depend on requested guest's architecture. This is described in below example:

| | |
|---|---|
| Requested Guest -----------------> | Hypervisor Arch |
| HP-UX31 --------------------------> | IA |
| Redhat ----------------------------> | x86 |
| Kiran(HP-UX) --------------------> | x86 |

If target Hypervisor is found in FIG. 5, guest is created following normal guest creation process. If target Hypervisor is not found in Table 1, it installs OS on top of bare metal system, then creates guest on top of it. This process is described further below.

Automatic installation of Multi-Architecture Host/Hypervisor/Bare-metal operating system is controlled from a single server, called as “Cloud Installation server”.

Cloud Installation Server Configuration and installation process:

When there is no available host/hypervisor that have enough resource to hold requested guest's configuration, a new bare metal is selected from pool/FIG. 3. In that bare metal we install operating system depending on its architecture. Target Bare-metal is PXE booted by Cloud Installation server. When target client system is booted, its NIC card triggers a DHCP request. The client announces its architecture on boot as a part of the DHCP transaction. The first packet broadcasted by the client is a DHCPDISCOVERY packet including the DHCP option 93 specified by RFC 4578. Where IA is defined in Type 2 and EFI Bytes code is defined in Type 7. Below is an example DHCP configuration file in Cloud controller, handling x86 and IA types of architecture:

```
class ″pxe-clients″ {
  match if substring (option vendor-class-identifier, 0, 9) = ″PXEClient″;
  elsif substring (option vendor-class-identifier, 15, 5) = ″00002″ {
    filename ″Rel_B.11.31/nbp.efi″;
}
###<Other architecture type>###
  elsif substring (option vendor-class-identifier, 15, 5) = ″00007″ {
    filename ″Linux/Grub64x.efi″;
  }
}
```

Installer DHCP server can intercept this requests and respond with standard information like IP, subnet mask, gateway, DNS. At the same time it can provide information about the location of TFTP server and boot image. In case of IA system, PXE client broadcasts DHCP class id PXEClient:Arch:00002, and Installer server send location of boot image location as Rel_B.11.31/nbp.efi. In case of ProLiant x86 system, DHCPREQUEST have class id PXEClient:Arch:00007, and Installer server sends boot file's location as Linux/Grub64x.efi or Linux/bootx64.efi as per selected bootloader.

When the IA and x86 client receives this information, it contacts the TFTP server configured in server for obtaining the boot image. Installer TFTP server sends the boot image (nbp.efi for IA and Grub64x.efi or bootx64.efi for x86), and the client executes it. HP-UX installation on IA hardware follows the conventional steps defined by Installer server. For x86, vmliunz and initramfs will be downloaded from TFTP server as defined in grub.conf and loads them. There is an automation application responsible for creating automation environment in Cloud Controller. As soon as target system booted, architecture specific bootloader loaded (in target systems memory) and this automation program runs (with architecture type as parameter) inside cloud controller. This application/script/program will prepare kickstart/post installation files on Cloud Controller. These Kickstart and post installation scripts will be responsible for installing hypervisor on Host (After OS installation) and guest VM creation with specified flavor (CPU, RAM, Disk, etc.). After Guest is created on target host, an image of guest pushed from cloud controller as normal guest installation process.

As an example, when target client boots that have mac address “98:4b:e1:05:d5:0a”, DHCP server executes an automation program that prepares cloud controller with NFS location of OS (That is going to be installed in target host), prepares kickstart/post installation scripts which will be responsible for installing specific hypervisor and creating guest on top of host.

```
host hostname {
  hardware ethernet 98:4b:e1:05:d5:0a
  execute(<Automation Program>, ″x86″);
  fixed-address 15.213.178.47;
  }
host hostnamehpux {
  hardware ethernet 00:15:60:04:58:64;
  execute(<Automation Program>, ″hpux″);
  fixed-address 15.213.178.48;
}
```

FIG. 6 is a diagram of a computing device 110 in accordance with the present disclosure. Computing device 110 can, for example, be in the form of a server or another suitable computing device within a network environment or in communication with a network environment or equipment thereof. In some implementations, As described in further detail below, computing device 110 includes a processing resource 112 and a memory resource 114 that stores machine-readable instructions 116, 118, 120, and 122. For illustration, the description of computing device 110 makes reference to various aspects of the diagrams and methods herein. However it is appreciated that computing device 110 can include additional, alternative, or fewer aspects, functionality, etc., than the implementations described elsewhere herein and is not intended to be limited by the related disclosure thereof.

Instructions 116 stored on memory resource 114 are, when executed by processing resource 112, to cause processing resource 112 to extract information about the architecture of a first bare metal server from a broadcasted packet. Instructions 116 can incorporate one or more aspects of blocks of method 100 or another suitable aspect of other implementations described herein (and vice versa).

Instructions 118 stored on memory resource 114 are, when executed by processing resource 112, to select, for the first bare metal server and based on the extracted architecture information, a first Operating System (“OS”) from a set of multiple OS's. Instructions 118 can incorporate one or more aspects of blocks of method 100 or another suitable aspect of other implementations described herein (and vice versa). Instructions 120 stored on memory resource 114 are, when executed by processing resource 112, to extract information about the architecture of a second bare metal server from a broadcasted packet. Instructions 120 can incorporate one or more aspects of blocks of method 100 or another suitable aspect of other implementations described herein (and vice versa).

Instructions 122 stored on memory resource 114 are, when executed by processing resource 112, to select, for the second bare metal server and based on the extracted architecture information, a second Operating System (“OS”) from a set of multiple OS's. Instructions 122 can incorporate one or more aspects of blocks of method 100 or another suitable aspect of other implementations described herein (and vice versa). In some implementations, instructions 122 stored on memory resource 114 are, when executed by processing resource 112, to install the first OS on the first bare metal server. In some implementations, instructions 122 stored on memory resource 114 are, when executed by processing resource 112, to install the second OS on the second bare metal server. In some implementations, instructions 122 stored on memory resource 114 are, when executed by processing resource 112, to select, for the first bare metal server and based on the extracted architecture information, a first bootloader from a set of multiple bootloaders.

In some implementations, instructions stored on memory resource 114 are, when executed by processing resource 112, to select, for the second bare metal server and based on the extracted architecture information, a second bootloader from a set of multiple bootloaders. In some implementations, instructions are, when executed by processing resource 112, to install the first bootloader on the first bare metal server. In some implementations, instructions are, when executed by processing resource 112, to install the second bootloader on the second bare metal server.

Processing resource 112 of computing device 110 can, for example, be in the form of a central processing unit (CPU), a semiconductor-based microprocessor, a digital signal processor (DSP) such as a digital image processing unit, other hardware devices or processing elements suitable to retrieve and execute instructions stored in memory resource 114, or suitable combinations thereof. Processing resource 112 can, for example, include single or multiple cores on a chip, multiple cores across multiple chips, multiple cores across multiple devices, or suitable combinations thereof. Processing resource 112 can be functional to fetch, decode, and execute instructions as described herein. As an alternative or in addition to retrieving and executing instructions, processing resource 112 can, for example, include at least one integrated circuit (IC), other control logic, other electronic circuits, or suitable combination thereof that include a number of electronic components for performing the functionality of instructions stored on memory resource 114. The term “logic” can, in some implementations, be an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Processing resource 112 can, for example, be implemented across multiple processing units and instructions may be implemented by different processing units in different areas of computing device 110.

Memory resource 114 of computing device 110 can, for example, be in the form of a non-transitory machine-readable storage medium, such as a suitable electronic, magnetic, optical, or other physical storage apparatus to contain or store information such as machine-readable instructions 116, 118, 120, and 122. Such instructions can be operative to perform one or more functions described herein, such as those described herein with respect to method 100 or other methods described herein. Memory resource 114 can, for example, be housed within the same housing as processing resource 112 for computing device 110, such as within a computing tower case for computing device 110 (in implementations where computing device 110 is housed within a computing tower case). In some implementations, memory resource 114 and processing resource 112 are housed in different housings. As used herein, the term “machine-readable storage medium” can, for example, include Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof. In some implementations, memory resource 114 can correspond to a memory including a main memory, such as a Random Access Memory (RAM), where software may reside during runtime, and a secondary memory. The secondary memory can, for example, include a nonvolatile memory where a copy of machine-readable instructions are stored. It is appreciated that both machine-readable instructions as well as related data can be stored on memory mediums and that multiple mediums can be treated as a single medium for purposes of description.

Memory resource 114 can be in communication with processing resource 112 via a communication link 124. Each communication link 124 can be local or remote to a machine (e.g., a computing device) associated with processing resource 112. Examples of a local communication link 124 can include an electronic bus internal to a machine (e.g., a computing device) where memory resource 114 is one of volatile, non-volatile, fixed, and/or removable storage medium in communication with processing resource 112 via the electronic bus.

In some implementations, one or more aspects of computing device 110 (e.g., a server or other equipment) can be in the form of functional modules that can, for example, be operative to execute one or more processes of instructions 116, 118, 120, or 122 or other functions described herein relating to other implementations of the disclosure. As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software can include hardware only (i.e., a hardware element with no software elements), software hosted at hardware (e.g., software that is stored at a memory and executed or interpreted at a processor), or hardware and software hosted at hardware. It is further appreciated that the term “module” is additionally intended to refer to one or more modules or a combination of modules. Each module of computing device 110 can, for example, include one or more machine-readable storage mediums and one or more computer processors.

In view of the above, it is appreciated that the various instructions of computing device 110 described above can correspond to separate and/or combined functional modules. For example, instructions 116 can correspond to an “architecture information extraction module” to extract information about the architecture of a first bare metal server from a broadcasted packet. Likewise, instructions 118 can correspond to an “OS selection module” to “select, for the first bare metal server and based on the extracted architecture information, a first OS from a set of multiple OS's.” It is further appreciated that a given module can be used for multiple functions. As but one example, in some implementations, a single module can be used to both extract architecture information (e.g., corresponding to the functionality of instructions 116) as well as to select an OS (e.g., corresponding to the functionality of instructions 118).

Certain implementations of device 110 can, for example, further include a suitable communication module to allow networked communication between network equipment. Such a communication module can, for example, include a network interface controller having an Ethernet port and/or a Fibre Channel port. In some implementations, such a communication module can include wired or wireless communication interface, and can, in some implementations, provide for virtual network ports. In some implementations, such a communication module includes hardware in the form of a hard drive, related firmware, and other software for allowing the hard drive to operatively communicate with other hardware. The communication module can, for example, include machine-readable instructions for use with communication the communication module, such as firmware for implementing physical or virtual network ports.

FIG. 7 illustrates a machine-readable storage medium 126 including various instructions that can be executed by a computer processor or other processing resource. In some implementations, medium 126 can be housed within a server or on another computing device. For illustration, the description of machine-readable storage medium 126 provided herein makes reference to various aspects of computing device 110 (e.g., processing resource 112) and other implementations of the disclosure (e.g., method 100). Although one or more aspects of computing device 110 (as well as instructions such as instructions 116, 118, 120, and 122) can be applied to or otherwise incorporated with medium 126, it is appreciated that in some implementations, medium 126 may be stored or housed separately from such a system. For example, in some implementations, medium 126 can be in the form of Random Access Memory (RAM), flash memory, a storage drive (e.g., a hard disk), any type of storage disc (e.g., a Compact Disc Read Only Memory (CD-ROM), any other type of compact disc, a DVD, etc.), and the like, or a combination thereof.

Medium 126 includes machine-readable instructions 128 stored thereon to cause processing resource 112 to receive, with a cloud controller, a request for the creation of a guest Virtual Machine (“VM”) on equipment controlled by the cloud controller. Instructions XX can, for example, incorporate one or more aspects of other suitable implementations described herein (and vice versa).

Medium 126 includes machine-readable instructions 130 stored thereon to cause processing resource 112 to detect a pre-boot architecture for the controlled equipment. Instructions 130 can, for example, incorporate one or more aspects of other suitable aspects of other implementations described herein (and vice versa). For example, in some implementations, the pre-boot architecture is one of Arc x86 or EFI IA32. In some implementations, detecting a pre-boot architecture for the controlled equipment includes extracting such information from a DHCP broadcasted packet. Medium 126 includes machine-readable instructions 132 stored thereon to cause processing resource 112 to load a bootloader on the controlled equipment based on the detected pre-boot architecture. Instructions 132 can, for example, incorporate one or more aspects of other suitable aspect of other implementations described herein (and vice versa).

Medium 126 includes machine-readable instructions 134 stored thereon to cause processing resource 112 to automatically install, on the controlled equipment, an OS and a guest VM on a hypervisor. Instructions 134 can, for example, incorporate one or more aspects of other implementations described herein (and vice versa). In some implementations, the cloud controller is configured with automation scripts and kickstart files for OS installation on the controlled equipment. In some implementations the cloud controller is to execute an automation script in response to a DHCP trigger. In some implementations, the automation script directs the cloud controller to a specific bootloader to be loaded on the controlled equipment.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. Furthermore, it should be appreciated that the systems and methods described herein can include various combinations and/or sub-combinations of the components and/or features of the different implementations described. Thus, features described with reference to one or more implementations can be combined with other implementations described herein.

As used herein, “logic” is an alternative or additional processing resource to perform a particular action and/or function, etc., described herein, which includes hardware, e.g., various forms of transistor logic, application specific integrated circuits (ASICs), etc., as opposed to machine executable instructions, e.g., software firmware, etc., stored in memory and executable by a processor. Further, as used herein, “a” or “a number of” something can refer to one or more such things. For example, “a number of widgets” can refer to one or more widgets. Also, as used herein, “a plurality of” something can refer to more than one of such things.

What is claimed is:

1. A method comprising:
detecting, with a cloud controller, a Central Processing Unit (CPU) architecture for a bare metal server;
selecting, based on the detected CPU architecture, a specific bootloader, specific Operating System (“OS”) and specific Virtual Machine (“VM”) for the bare metal server; and
installing the selected bootloader, OS, and VM on the bare metal server.

2. The method of claim 1, wherein detecting the CPU architecture is based on a received Dynamic Host Configuration Protocol (“DHCP”) packet broadcasted by the bare metal server during a Pre-boot eXecution Environment (“PXE”) boot.

3. The method of claim 1, wherein detecting the CPU architecture is based on a packet broadcasted by the bare metal server in the form of a DHCPDISCOVERY packet including a DHCP option 93 specified by RFC 4578.

4. The method of claim 1, wherein the bare metal server is a host server.

5. The method of claim 1, wherein the VM is a guest VM.

6. The method of claim 1, further comprising:
registering information about a hypervisor of the bare metal server via a Representational State Transfer (“REST”) call.

7. The method of claim 1, wherein the information about a hypervisor includes one or more of Media Access Control (“MAC”) Address, Architecture Type, amount of Random Access Memory (“RAM”), and CPU size.

8. The method of claim 1, wherein the cloud controller is to install a hypervisor on the bare metal server.

9. The method of claim 1, wherein the cloud controller is to install a first OS on a hypervisor having a first architecture and the cloud controller is to install a second OS on a hypervisor having a second architecture, wherein the first and second OS's are different OS's and the first and second architectures are different architectures.

10. The method of claim 1, wherein a single cloud controller is to handle the respective installation of bootloaders, OS's, and VM's on multiple bare metal servers with different CPU architectures.

11. The method of claim 1, wherein the cloud controller provides an option for a manual override of the selected bootloader, OS, or VM.

12. A non-transitory machine readable storage medium having stored thereon machine readable instructions to cause a computer processor to:
receive, with a cloud controller, a request for the creation of a guest Virtual Machine (“VM”) on equipment controlled by the cloud controller;
detect a pre-boot architecture for the controlled equipment;
load a bootloader on the controlled equipment based on the detected pre-boot architecture; and
automatically install, on the controlled equipment, an Operating System (“OS”) and a guest VM on a hypervisor.

13. The medium of claim 12, wherein the instructions are to cause the computer processor to:
in response to a DHCP trigger, execute an automation script on the cloud controller.

14. The medium of claim 12, wherein detecting a pre-boot architecture for the controlled equipment includes extracting such information from a DHCP broadcasted packet.

15. The medium of claim 12, wherein the cloud controller is configured with automation scripts and kickstart files for OS installation on the controlled equipment.

16. The medium of claim 15, wherein the automation script directs the cloud controller to a specific bootloader to be loaded on the controlled equipment.

17. A cloud controller comprising:
a processing resource; and
a memory resource storing machine readable instructions to cause the processing resource to:
extract information about the architecture of a first bare metal server from a broadcasted packet;
select, for the first bare metal server and based on the extracted architecture information, a first Operating System (“OS”) from a set of multiple OS's;
extract information about the architecture of a second bare metal server from a broadcasted packet; and
select, for the second bare metal server and based on the extracted architecture information, a second Operating System (“OS”) from a set of multiple OS's.

18. The cloud controller of claim 17, wherein the memory resource stores machine readable instructions to cause the processing resource to:
install the first OS on the first bare metal server; and
install the second OS on the second bare metal server.

19. The cloud controller of claim 17, wherein the memory resource stores machine readable instructions to cause the processing resource to:
select, for the first bare metal server and based on the extracted architecture information, a first bootloader from a set of multiple bootloaders;
select, for the second bare metal server and based on the extracted architecture information, a second bootloader from a set of multiple bootloaders.

20. The cloud controller of claim 19, wherein the memory resource stores machine readable instructions to cause the processing resource to:
install the first bootloader on the first bare metal server; and
install the second bootloader on the second bare metal server.
